(19) United States
(12) Patent Application Publication
(10) Pub. No.: US 2010/0057430 A1
(43) Pub. Date: Mar. 4, 2010

(54) Multiple Language Communication System

(75) Inventor: Frances J.D. Moore-Jones, Houston, TX (US)

Correspondence Address: Tod T. Tumey, P.O. BOX 22188, HOUSTON, TX, 77227-2188, US

(73) Assignee: Translated Phrase LLC, Houston, TX (US)

(21) Appl. No.: 12/198,169

(22) Filed: Aug. 26, 2008

(51) Int. Cl. G06F 17/28

(52) U.S. Cl. 704/2

(57) ABSTRACT

A method and system for communicating in more than one language includes a communication system of cards. In one embodiment, the communication system of cards is for a communicator to communicate in a first language to a receiver in a second language. The communication system includes a communication card comprising a communication and a translated communication. The communication is in the first language, and the translated communication is a translation of the communication in the first language to the second language. The communication is a task for the receiver. The communication system also includes an instruction card comprising an instruction communication and a translated instruction communication. The instruction communication is in the first language, and the translated instruction communication is in the second language. The instruction communication is an instruction from the communicator to the receiver or from the receiver to the communicator. The communication system also includes visual illustrations.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

This invention relates to the field of communication and more specifically to the field of communicating in multiple languages with cards.

2. Background of the Invention

There has been an increased demand for developing means for communicating to another in a language other than the language of the communicator. For instance, a communicator that speaks English may have a need to communicate to another that only understands another language such as Spanish. Typical methods for such communication include using a bilingual dictionary to translate words or phrases from the communicator's language to the other language. Drawbacks to such methods include inefficiencies such as finding the proper wording to communicate a task as well as the time involved in locating the proper translations in the bilingual dictionary.

Consequently, there is a need for an improved communication system for communicating in other languages. Additional needs include an improved communication system for communicating in another language.

### BRIEF SUMMARY OF SOME OF THE PREFERRED EMBODIMENTS

These and other needs in the art are addressed in one embodiment by a communication system of cards for a communicator to communicate in a first language to a receiver in a second language. The communication system includes a communication card comprising a communication and a translated communication. The communication is in the first language, and the translated communication is a translation of the communication in the first language to the second language. The communication is a task for the receiver. The communication system also includes an instruction card comprising an instruction communication and a translated instruction communication. The instruction communication is in the first language and the translated instruction communication is in the second language. The instruction communication is an instruction from the communicator to the receiver.

In another embodiment, these and other needs in the art are addressed by a method of communicating. A communicator communicates in a first language to a receiver in a second language. The method includes providing a plurality of communication cards. Each of the plurality of communication cards comprises a communication and a translated communication. The communication is in the first language, and the translated communication is a translation of the communication in the first language to the second language. The communication is a task for the receiver. The method also includes presenting at least one of the communication cards to the receiver from the communicator. The method further includes providing a plurality of instruction cards. Each of the plurality of instruction cards comprises an instruction communication and a translated instruction communication. The instruction communication is in the first language, and the translated instruction communication is in the second language. The instruction communication is an instruction from the communicator to the receiver. In addition, the method includes presenting at least one of the instruction cards to the receiver from the communicator.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other embodiments for carrying out the same purposes of the present invention. It should also be realized by those skilled in the art that such equivalent embodiments do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIG. 1 illustrates a communication card with a communication, a translated communication, and a visual;

FIG. 2 illustrates a communication card with a communication, a translated communication and a visual;

FIG. 3 illustrates a communication card with a communication, a translated communication, a visual, and a secondary communication;

FIG. 4 illustrates a communication card with a secondary communication text;

FIG. 5 illustrates another embodiment of a communication card with a secondary communication text;

FIG. 6 illustrates an embodiment of a communication card with a second translated communication;

FIG. 7 illustrates an embodiment of a communication card without a visual;

FIG. 8 illustrates an embodiment of the communication card of FIG. 7 with a translated secondary communication text;

FIG. 9 illustrates another embodiment of the communication card of FIG. 7 with a translated secondary communication text;

FIG. 10 illustrates an alternative embodiment of the communication card of FIG. 7 with a translated secondary communication text; and

FIG. 11 illustrates another embodiment of the communication card of FIG. 7 with a translated secondary communication text.

### DETAILED DESCRIPTION OF THE PREFERRED EMBODIMENTS

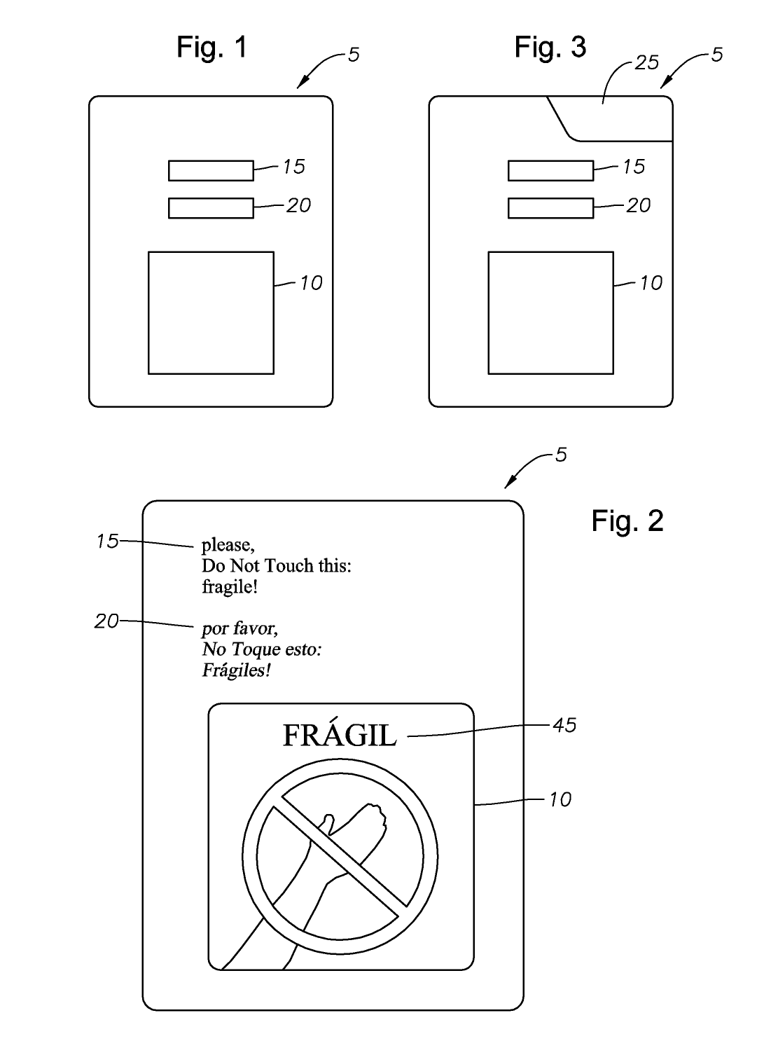

FIG. 1 illustrates a communication card 5 comprising visual 10, communication 15, and translated communication 20. A communicator communicates information via communication 15 and translated communication 20 to a receiver with communication card 5. A communicator refers to a person that is communicating the information of communication 15 and translated communication 20. The receiver is a person that is receiving the translated communication 20. Communication card 5 may comprise any size and configuration suitable for communicating the information. In an embodiment, communication card 5 is a card. In some embodiments, communication card 5 is a playing card without rank and suit. Visual 10 is a visual demonstration of communication 15 and translated communication 20. In an embodiment, visual 10 is any visual presentation suitable for visually demonstrating communication 15 and translated communication 20. Without limitation, visual 10 may be a picture, drawing, diagram, photograph, illustration, and/or schematic. In alternative embodiments, visual 10 also includes written text. The written text is in the language of communication 15 and/or translated communication 20. The information communicated by communication 15 and translated communication 20 may be any desirable idea, gesture, action, thought, message, instruction, and the like. In an embodiment, communication card 5 communicates a task to the receiver. Communication 15 is written in a language understood by the communicator. Translated communication 20 is a written translation of communication 15 in a language understood by the receiver. Without limitation, communication card 5 allows the communicator to communicate information to a receiver when the communicator and/or receiver do not understand the language of the other. It is to be understood that communication 15 and translated communication 20 may be in any desirable language. In addition, communication 15 and translated communication 20 may be in any written form suitable for communicating the information such as in sentence form, phrase form, or single word form. For instance, in an embodiment, the communicator understands English but does not understand Spanish, and the receiver understands Spanish but does not understand English. In such an embodiment, communication 15 is in English, and translated communication 20 is in Spanish.

FIG. 2 illustrates an embodiment of communication card 5 in which communication 15 is in English and translated communication 20 is in Spanish. As shown, translated communication 20 is a Spanish translation of communication 15. As further illustrated, visual 10 visually demonstrates communication 15 and translated communication 20. In the embodiment as illustrated in FIG. 2, visual 10 also includes a translated writing 45 that facilitates the demonstration of visual 10.

FIG. 3 illustrates an embodiment in which communication card 5 further includes secondary communication 25. In an embodiment secondary communication 25 is a communication to be used as a reference guide for the communicator. In some embodiments, secondary communication 25 serves as an index. The communicator may use the index (i.e., secondary communication 25) to locate the appropriate communication cards 5. Without limitation, using secondary communication 25 as an index facilitates location of the appropriate communication card 5. Secondary communication 25 may be in writing (i.e., secondary communication text 30 (not illustrated)) and/or in color. In some embodiments, secondary communication 25 includes a color that corresponds to an index for the communicator. In an embodiment, secondary communication 25 indicates the importance, type, and/or frequency of the information communicated in communication 15 and translated communication. 20. In an embodiment in which secondary communication 25 includes color, the colors may correspond to levels of importance, the frequency, or the type of the communicated information in communication 15. For instance, in an embodiment in which communication 15 and translated communication 20 communicate tasks, a red secondary communication 25 may indicate to the communicator that this is a task to be accomplished “often.” In such an embodiment, an orange secondary communication 25 may indicate to the communicator that this task may be accomplished “sometimes,” and a black secondary communication 25 may not be related to the frequency of a task but may be related to a communication such as an instruction related to the task. It is to be understood that the significance of the colors and the information to which they correspond is understood by the communicator and/or receiver.

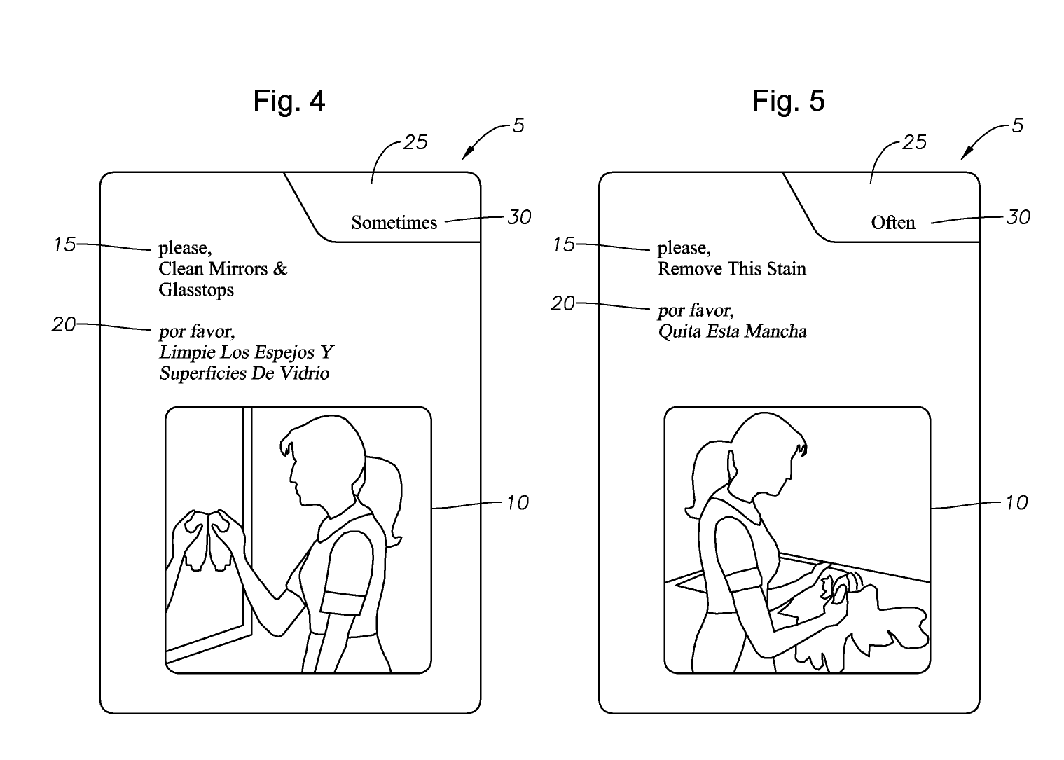

FIG. 4 illustrates an embodiment of communication card 5 in which secondary communication 25 includes secondary communication text 30. In this embodiment, secondary communication text 30 is in the language of communication 15, which is English. In other embodiments, the language of communication 15 may be any other language. As illustrated, secondary communication text 30 indicates the frequency (i.e., “sometimes” as illustrated in FIG. 4 or “often” as illustrated in FIG. 5) at which the communicator expects the task of communication 15 and translated communication 20 to be accomplished. In an embodiment, secondary communication 25 assists the communicator to index and/or organize the communication cards 5. In some embodiments, secondary communication 25 also includes a color corresponding to information related to the secondary communication text 30. For instance, secondary communication 25 may include a color that has been designated to correspond to the frequency. As a non-limiting example, the color of secondary communication 25 of FIG. 4 may be orange, and the color of secondary communication 25 of FIG. 5 may be red. In embodiments in which the color corresponds to information and the communicator understands the significance of the color, secondary communication 25 may communicate to the communicator the frequency “sometimes,” as illustrated in FIG. 4, of the task without providing a translation of secondary communication text 30 into the language of translated communication 20.

FIG. 5 illustrates an embodiment of communication card 5 in which secondary communication 25 includes secondary communication text 30. In this embodiment, secondary communication text 30 is in the language of communication 15, which is English. As illustrated, secondary communication text 30 indicates the frequency (i.e., “often”) at which the communicator expects the task of communication 15 and translated communication 20 to be accomplished.

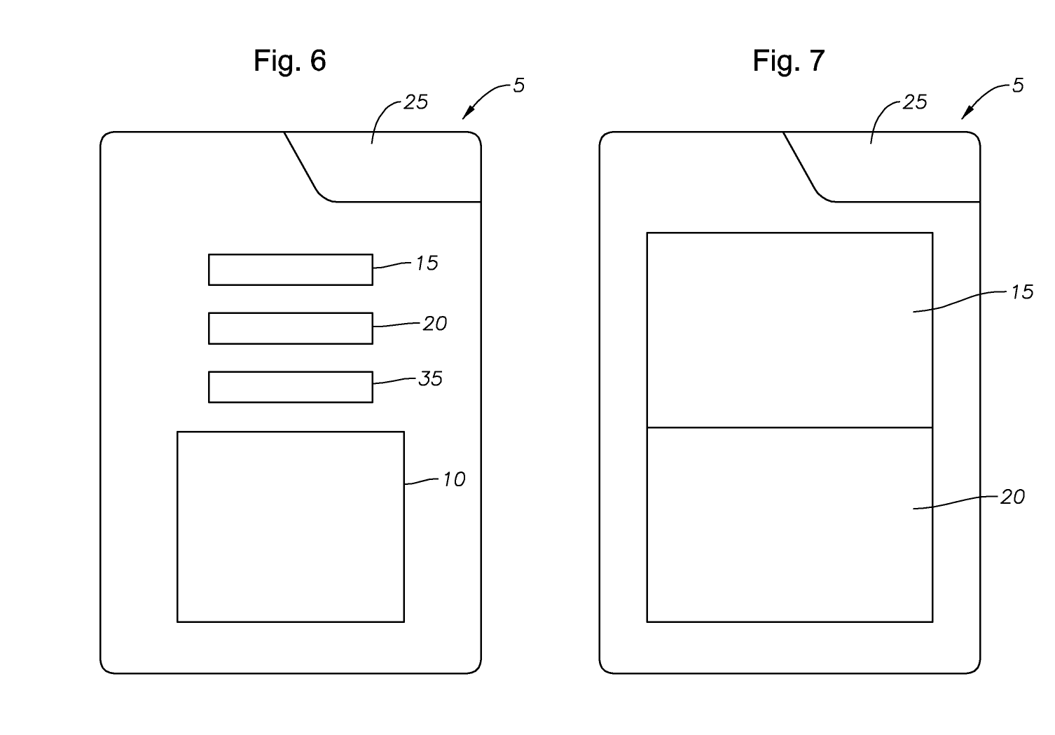

It is to be understood that communication cards 5 are not limited to translation of communication 15 into one language but may include translations of communication 15 into more than one language. FIG. 6 illustrates an embodiment in which communication card 5 includes communication 15, translated communication 20, and second translated communication 35. Second translated communication 35 is a translation of communication 15 in a different language than translated communication 20. Such an embodiment allows the communicator to communicate using communication card 5 to multiple receivers that understand different languages.

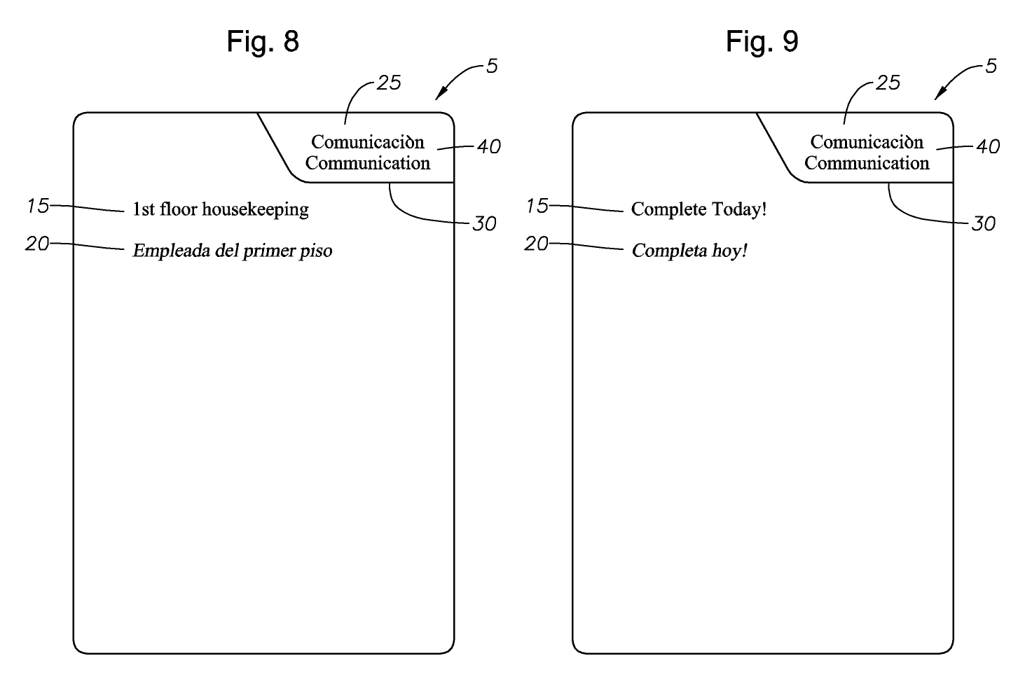

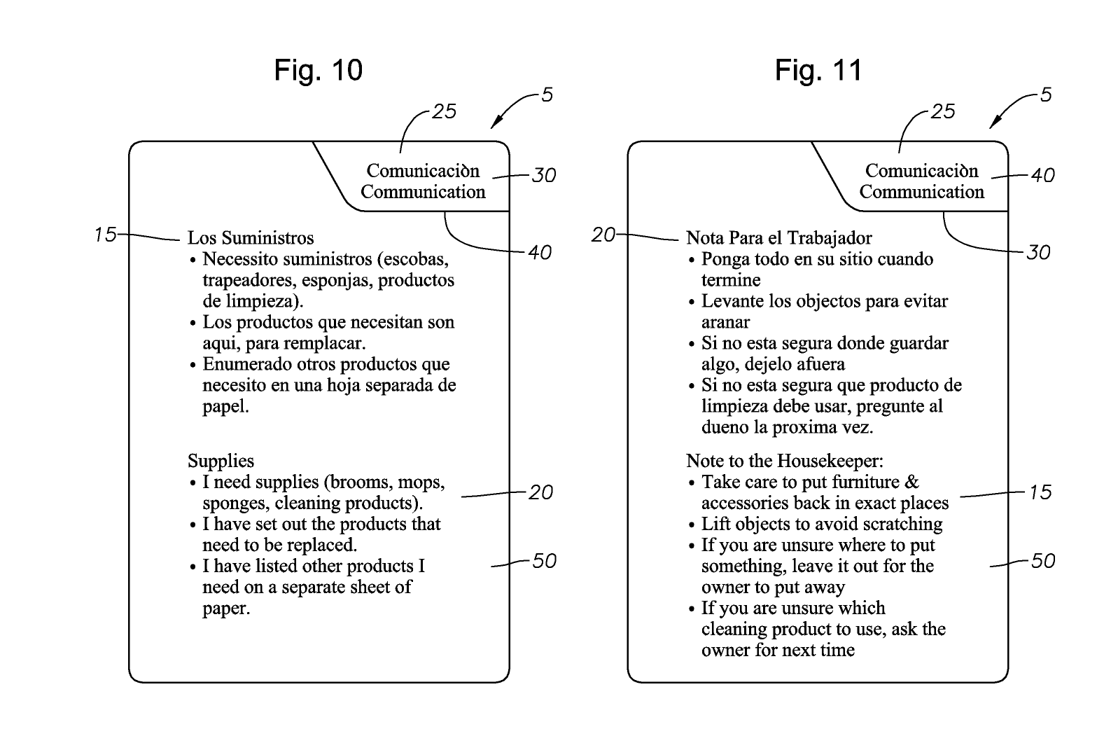

It is also to be understood that communication card 5 is not limited to including visual 10. Instead, in an embodiment as illustrated in FIG. 7, communication card 5 includes communication 15 and translated communication 20 with no visual 10. In an embodiment, such communication cards 5 without visual 10 are instruction cards that provide instructions to the receiver or instructions from the receiver to the communicator. Any desirable instructions may be provided. For instance, the instruction cards may be used to explain to the receiver how to use a communication system of cards that includes a plurality of communication cards 5 (i.e., a deck of communication cards 5). FIGS. 8 and 9 illustrate embodiments of communication cards 5 used as such instruction cards with no visual 10. In embodiments as illustrated in FIGS. 8 and 9, communication cards S also include secondary communication 25 including a secondary communication text 30 in the same language as communication 15 and a translated secondary communication text 40, which is a translation of secondary communication text 30 to the same language of translated communication 20. In some embodiments as illustrated in FIGS. 8 and 9, the written text of secondary communication text 30 and translated secondary communication text 40 indicate to the communicator and receiver that the communication card 5 is an instruction card and not a communicator of a task. For instance, secondary communication text 30 indicates “communication.” In some embodiments, secondary communication 25 has a color that corresponds to an information card. For instance, secondary communication 25 may be black, which corresponds to information cards. In some embodiments, the instruction cards are used in a communication system of cards to provide instructions in relation to communication cards 5 that provide tasks. The instruction cards may also be used by the receiver to communicate back to the communicator. For instance, the instruction cards may be used by the receiver to indicate needed supplies, indicate to the communicator which tasks have been completed, and relay any other desirable communications. FIG. 10 illustrates an embodiment in which the receiver is using communication card 5 as an instruction card to communicate to the communicator. In alternative embodiments, communication cards 5 with no visual 10 may be communicating a task.

It is to be understood that communication cards 5 are not limited to communication 15 disposed above translated communication 20 but instead may include any positioning of communication 15 and translated communication 20 on face 50 of communication card 5. For instance, in an embodiment as illustrated in FIG. 11, translated communication 20 is disposed above communication 15.

In embodiments as illustrated in FIGS. 3-11, secondary communication 25 is disposed in the upper right corner of face 50. Without limitation, secondary communication 25 is disposed in the upper right corner of face 50 to facilitate the communication of the information of secondary communication 25. However, it is to be understood that communication card 5 is not limited to secondary communication 25 disposed in the upper right corner. In alternative embodiments (not illustrated), secondary communication 25 is disposed at any location on face 50 suitable for communicating the information of secondary communication 25. Secondary communication text 30 and translated secondary communication text 40 may also be disposed in any order suitable for communication of the information.

In an embodiment, a deck of cards includes a plurality of communication cards 5. The deck of cards may include any number of communication cards 5. In an embodiment, the deck of cards includes 54 cards. The deck of cards includes a plurality of communication cards 5 that communicate tasks from the communicator to the receiver. In an embodiment, the deck of cards includes one communication card 5 that is an instruction card. In other embodiments, the deck of cards includes more than one communication card 5 that are instruction cards. In an embodiment, the deck of cards includes a communication card 5 that is an instruction card providing instructions to the receiver on how to use the communication cards 5 that communicate tasks. In other embodiments, the deck of cards includes at least one communication card 5 that is an instruction card providing instructions related to the receiver accomplishing the tasks of one or a plurality of communication cards 5.

In an embodiment, a communication system of cards includes a plurality of communication cards 5. The communication system may include any desirable number of communication cards 5. In some embodiments, a communication system of cards includes a deck of communication cards 5. In an embodiment, the communication system of cards includes repeatable activities that may be communicated from the communicator to the receiver. The communication system of cards includes a plurality of communication cards 5 that communicate tasks from the communicator to the receiver or instructions from the receiver to the communicator. In an embodiment, the communication system of cards includes one communication card 5 that is an instruction card. In other embodiments, the communication system of cards includes more than one communication card 5 that are instruction cards. In an embodiment, the communication system of cards includes a communication card 5 that is an instruction card providing instructions to the receiver on how to use the communication system of cards. In other embodiments, the communication system of cards includes at least one communication card 5 that is an instruction card providing instructions related to the receiver accomplishing the tasks of one or a plurality of communication cards 5.

As a non-limiting example of a communication system of cards, the communicator understands English and desires to instruct the receiver on various domestic house cleaning tasks. In such an example, the receiver understands Spanish. The communication system of cards includes a plurality of communication cards 5 that instruct the receiver on various domestic tasks. For instance, the embodiments of communication cards 5 shown in FIGS. 4 and 5 may be used to communicate tasks from the communicator to the receiver. With each communication card 5 having different communications 15, each communication 15 allows the communicator to select the desired communication cards 5 for the desired tasks. The corresponding translated communications 20 then allow the receiver to understand the desired tasks, which are facilitated by visuals 10. In alternative embodiments, the communicator may also provide a product to be used when accomplishing the task. In some embodiments, the system of cards includes communication cards 5 with secondary communications 25. For instance, communication cards 5 may include secondary communication text 30 and/or translated secondary communication text 40 (not illustrated) to indicate frequency. As an example, the communication card 5 of FIG. 5 indicates the task of communication 15 to be accomplished “often” as indicated by secondary communication 25. The communication system of cards may also include secondary communications 25 that are color coordinated to indicate frequency or importance. In some embodiments, a communication card 5 may be an information card as illustrated in FIG. 2 that may be provided with a related communication card or cards 5. For instance, a communication card 5 (i.e., information card) that provides instructions of a warning as in the embodiment of FIG. 2 may be shown to the receiver by a fragile product to instruct the receiver of the communication of the instruction (i.e., do not touch) of the particular communication card 5. In some instances, a communication card 5 such as the communication cards 5 of FIGS. 8 and 9 may be provided with a desired communication card or cards 5 that communicate tasks. For instance, the communication card 5 of FIG. 9 may be provided to the receiver with the communication card 5 of FIG. 5 to instruct the receiver with the task to “remove this stain” with the instruction to be “complete today,” therefore providing a task and due date for the task. In such an instance, secondary communication 25 on each communication card 5 indicates to the communicator and receiver whether the communication card 5 is a task card (FIG. 5) or instruction card (FIG. 9). In further instances, instruction cards such as the communication card 5 of FIG. 11 may be used to provide instructions to the receiver that may be difficult to illustrate with a visual 10. The communication system of cards also includes embodiments in which the receiver may use instruction cards such as the communication card 5 of FIG. 10 to indicate to the communicator products that are needed or any other desirable communication to the communicator. For instance, the receiver presents such communication cards 5 to the communicator when desired. In some embodiments wherein the system comprises a deck of cards, communication cards 5 with tasks may be grouped together in the deck, and communication cards 5 that are information cards may be grouped together. In other embodiments, communication cards 5 with similar subject matter may also be grouped together in the deck. It is to be understood that these embodiments are only illustrative as the communication system of cards may include any variety of related domestic tasks and instructions.

It is to be understood that communication cards 5 are not limited to a particular language but may include any languages.

Although the present invention and its advantages have been described in detail, it should be understood that various changes, substitutions and alterations may be made herein without departing from the spirit and scope of the invention as defined by the appended claims.

What is claimed is:

1. A communication system of cards for a communicator to communicate in a first language to a receiver in a second language, comprising:
a communication card comprising a communication and a translated communication, wherein the communication is in the first language and the translated communication is a translation of the communication in the first language to the second language, and wherein the communication is a task for the receiver; and
an instruction card comprising an instruction communication and a translated instruction communication, wherein the instruction communication is in the first language and the translated instruction communication is in the second language, wherein the instruction communication is an instruction from the communicator to the receiver.

2. The communication system of claim 1, wherein the communication card further comprises a secondary communication.

3. The communication system of claim 2, wherein the secondary communication comprises a secondary communication text.

4. The communication system of claim 3, wherein the secondary communication further comprises a translated secondary communication text.

5. The communication system of claim 2, wherein the secondary communication comprises a color, and wherein the color corresponds to an index for the communicator.

6. The communication system of claim 1, wherein the instruction card further comprises a secondary communication.

7. The communication system of claim 6, wherein the secondary communication comprises a secondary communication text.

8. The communication system of claim 7, wherein the secondary communication further comprises a translated secondary communication text.

9. The communication system of claim 6, wherein the secondary communication comprises a color, and wherein the color corresponds to an index for the communicator.

10. The communication system of claim 1, further comprising at least one further instruction card, wherein the instruction communication of the at least one further instruction card is an instruction from the receiver to the communicator.

11. The communication system of claim 1, wherein the communication card farther comprises a second translated communication, wherein the second translated communication is a translation of the communication in the first language to a third language.

12. The communication system of claim 1, comprising a plurality of communication cards, wherein the communication of each of the plurality of communication cards is a different task for the receiver.

13. The communication system of claim 1, comprising a plurality of instruction cards, wherein the instruction communication of each of the plurality of instruction cards is a different instruction from the communicator to the receiver.

14. The communication system of claim 1, further comprising a deck of cards comprising a plurality of the communication cards and a plurality of the instruction cards.

15. The communication system of claim 1, wherein the communication card further comprises a visual.

16. The communication system of claim 15, wherein the visual further comprises a translated writing.

17. The communication system of claim 1, comprising at least one further communication card, wherein each of the at least one further communication cards does not comprise a visual.

18. The communication system of claim 1, wherein the instruction communication is an instruction on accomplishing the task.

19. A method of communicating, wherein a communicator communicates in a first language to a receiver in a second language, comprising:
(A) providing a plurality of communication cards, wherein each of the plurality of communication cards comprises a communication and a translated communication, and wherein the communication is in the first language and the translated communication is a translation of the communication in the first language to the second language, and further wherein the communication is a task for the receiver;
(B) presenting at least one of the communication cards to the receiver from the communicator;
(C) providing a plurality of instruction cards, wherein each of the plurality of instruction cards comprises an instruction communication and a translated instruction communication, wherein the instruction communication is in the first language and the translated instruction communication is in the second language, and wherein the instruction communication is an instruction from the communicator to the receiver; and
(D) presenting at least one of the instruction cards to the receiver from the communicator.

20. The method of claim 19, further comprising (E) providing at least one instruction card with the instruction communication comprising an instruction from the receiver to the communicator, and wherein the receiver presents the at least one instruction card to the communicator.
